(19) United States
(12) Patent Application Publication
(10) Pub. No.: US 2009/0315788 A1
(43) Pub. Date: Dec. 24, 2009

(54) ELECTRONIC DEVICE

(75) Inventor: Toshiyuki Hirota, Hino-shi (JP)

Correspondence Address: BLAKELY SOKOLOFF TAYLOR & ZAFMAN LLP, 1279 OAKMEAD PARKWAY, SUNNYVALE, CA, 94085-4040, US

(73) Assignee: KABUSHIKI KAISHA TOSHIBA, Tokyo (JP)

(21) Appl. No.: 12/404,121

(22) Filed: Mar. 13, 2009

(30) Foreign Application Priority Data
Jun. 24, 2008 (JP) 2008-164945

(51) Int. Cl. H01Q 1/24; G06F 1/16

(52) U.S. Cl. 343/702; 361/679.27

(57) ABSTRACT

According to one embodiment, an electronic device includes a metal-made housing including an opening portion, an antenna provided to partially overlap with the opening portion within the housing, with which radio communications are carried out with an outside, and an insulating cover provided to close the opening portion. The cover is fixed to the housing via the antenna.

### CROSS-REFERENCE TO RELATED APPLICATIONS

This application is based upon and claims the benefit of priority from Japanese Patent Application No. 2008-164945, filed Jun. 24, 2008, the entire contents of which are incorporated herein by reference.

### BACKGROUND

1. Field

One embodiment of the invention relates to an electronic device comprising an antenna used for radio communications.

2. Description of the Related Art

Jpn. Pat. Appln. KOKAI Publication No. 2006-13797 discloses a mobile information terminal which employs a housing with a radio shielding property and enables stable radio communications. The mobile information terminal includes a main body, a rear cover mounted to be openable/closable to the main body with a hinge or the like, and a liquid crystal display mounted on an inner side of the rear cover. The rear cover is formed of a carbon fiber-reinforced resin having an electro-conductivity. The rear cover includes a rectangular-shaped recess portion on its outer side. A plate-like antenna is mounted inside the recess portion.

In this mobile information terminal, the plate-like antenna is provided on an outer side of the conductive housing. With this structure, radio waves are not shielded by the housing, and therefore the radio communications are stabilized.

Here, in the case where an antenna is placed inside a conductive housing, if an opening portion is made in a part of the housing, the opening portion, in some cases, makes radio communications with an external device possible through the opening portion in this case, the opening portion is closed with a cover or the like, formed of a material which does not shield radio waves. Further, in many cases, the cover is supported with a metal-made supporting structure projecting from the housing towards the opening portion. On the other hand, the antenna, in order to stably transmit and receive radio waves with outside, needs to be placed a certain distance away from this metal-made supporting structure. For this reason, the space where the antenna can be installed inside the housing is small, and therefore the conventional type of electronic device is still susceptible to improvement in terms of internal space.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary perspective view showing a portable computer viewed from a front, which is an example of the electronic device according to the first embodiment;

FIG. 2 is an exemplary perspective view of the portable computer shown in FIG. 1, when viewed from a back;

FIG. 3 is an exemplary plan view of a back cover of a display unit of the portable computer shown in FIG. 2, when viewed from inside;

FIG. 4 is an exemplary perspective view of an antenna and a coaxial cable of the display unit shown in FIG. 3;

FIG. 5 is an exemplary plan view showing a peripheral structure of an antenna of a potable computer according to the second embodiment;

FIG. 6 is an exemplary plan view showing a peripheral structure of an antenna of a potable computer according to the third embodiment;

FIG. 7 is an exemplary plan view of a back cover of a display unit of the portable computer according to the fourth embodiment, when viewed from inside; and

FIG. 8 is an exemplary plan view of a back cover of a display unit of the portable computer according to the fifth embodiment, when viewed from inside.

### DETAILED DESCRIPTION

Various embodiments according to the invention will be described hereinafter with reference to the accompanying drawings. In general, according to one embodiment of the invention, an electronic device includes a metal-made housing including an opening portion, an antenna provided to partially overlap with the opening portion within the housing, with which radio communications are carried out with an outside, and an insulating cover provided to close the opening portion. The cover is fixed to the housing via the antenna

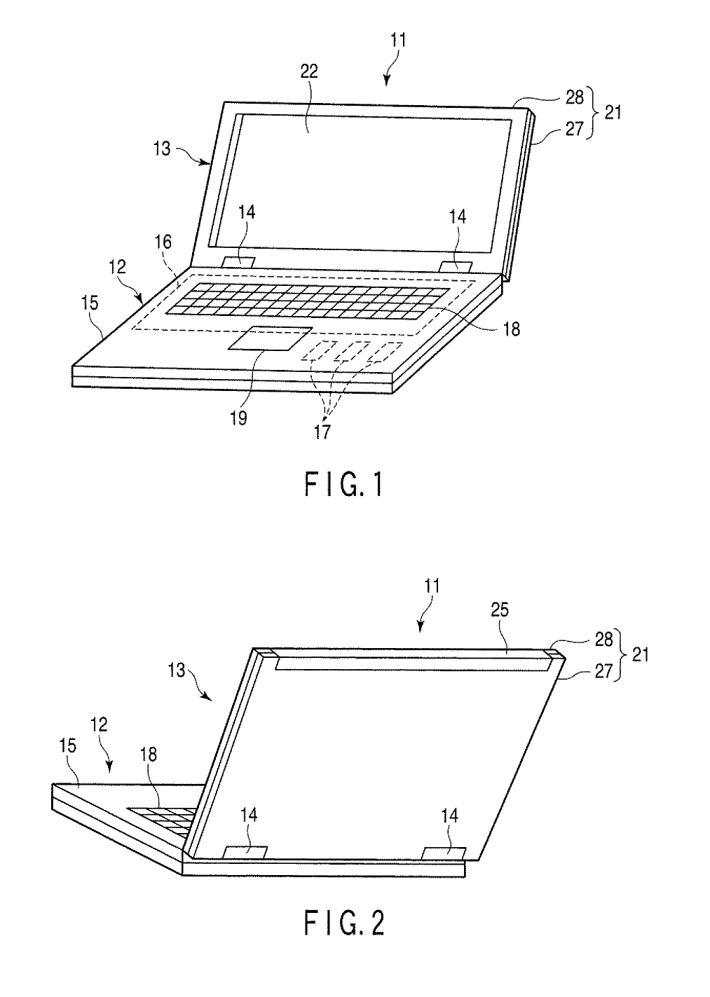

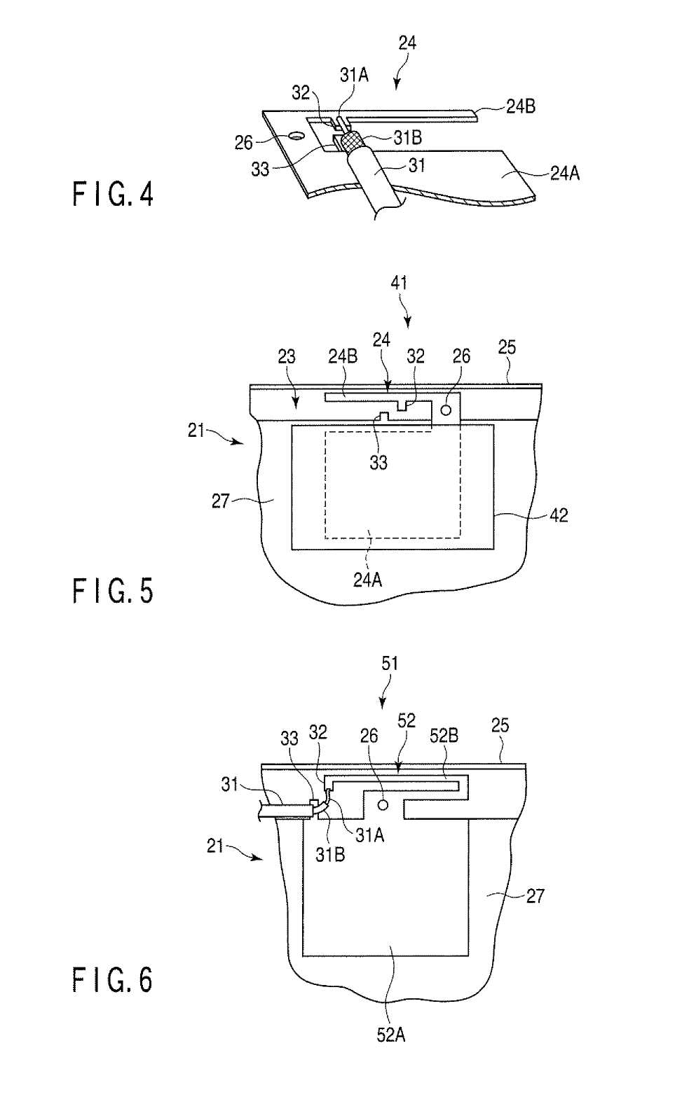

An embodiment of the electronic device will now be described with reference to FIGS. 1 to 4. This embodiment will be described in connection with a case where the present invention is applied to a portable computer, which is a so-called notebook-type personal computer as an example of the electronic device.

As shown in FIG. 1, a portable computer 11 includes a main body unit 12, a display unit 13 and a hinge portion 14 provided between the main body unit 12 and the display unit 13. The hinge portion 14 supports the display unit 13 so as to be pivotable. The hinge portion 14 supports the display unit 13 so as to be pivotable between a state where the display unit 13 is close to the main body unit 12 and a state where the display unit 13 is open to the main body unit 12.

The main body unit 12 includes a metal-made main body cabinet 15, a printed circuit board 16 and a radio module 17, which are housed inside the main body cabinet 15, a keyboard 18 and a touch pad 19, which are mounted to the main body cabinet 15.

The printed circuit board 16 includes a plurality of circuit parts including CPU. In FIG. 1, there are three radio modules 17 shown.

As shown in FIGS. 1 to 3, the display unit 13 includes a metal-made display cabinet 21, a liquid crystal display 22, which is an example of the display housed inside the display cabinet 21, an opening portion 23 made in the display cabinet 21, a plurality of antennas 24 provided inside the display cabinet 21, and a insulating cover 25 provided to close the opening portion 23. The cover 25 is formed of, for example, a synthetic resin. The cover 25 includes cylindrical projections not shown in the figures, each to be welded to a mount portion 26 of respective one of the antennas 24, which will be described later. The cover 25 is fixed to the display cabinet 21 via the antennas 24. The opening portion 23 is made in the display cabinet 21 at a position on an opposite side to that of the hinge portion 14.

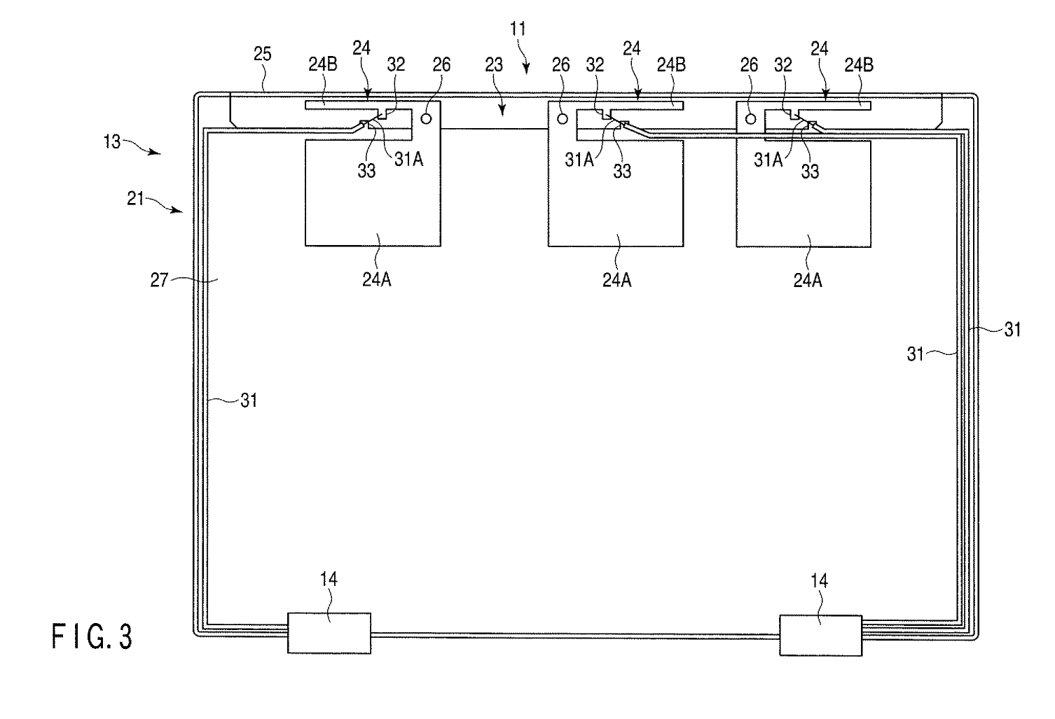

The antennas 24 each adhered to the display cabinet 21 such as to partially extend off towards an inner side of the opening portion 23. In other words, the antennas 24 are each provided to partially overlap with the opening portion 23. Each of the antennas 24 is compatible with communication formats such as Bluetooth (registered trademark), wireless LAN, wireless WAN, WiMAX, UWB and GPS, or mobile telephone formats such as 3G and 3.5G. In FIG. 3, there are three of the antennas 24 shown.

The display cabinet 21 is formed of, for example, a magnesium alloy. The display cabinet 21 includes a back cover 27 which covers a back portion of the liquid crystal display 22 and a frame-like mask 28 which surrounds a front portion of the liquid crystal display 22. Inside the display cabinet 21, a coaxial cable 31 is arranged such as to detour the liquid crystal display 22. The coaxial cable 31 used here is of a type having a diameter of about 0.8 mm to 1.4 mm. The main body cabinet 15 is arranged such as to straddle over the display cabinet 21 and the hinge portion 14. That is, the coaxial cable 31 connects the radio modules 17 of the main body unit 12 to the antennas 24 of the display unit 13.

The antennas 24 are each formed of, for example a copper-made metal sheet, and can carry out radio communications with the outside. The antennas 24 each contain a ground portion 24A having a square plate shape, a conductor portion 24B projecting linearly from the ground portion 24A and a mount portion 26 formed on the conductor portion 24B. The ground portion 24A is adhered to the display cabinet 21 with, for example, a double-sided tape. The conductor portion 24B projects towards the opening portion 23. The conductor portion 24B projects towards a direction away from the ground portion 24A a halfway through, and then bends in a direction parallel to the ground portion 24A. That is, in this embodiment, the antennas 24 are each formed to have a F-letter shape in reverse.

The mount portion 26 is a through hole made in a central portion of the conductor portion 24B. As the projection of the cover 25 is inserted to the mount portion 26, followed by heating, the projection is welded to the mount portion 26. It should be noted that in this embodiment, the cover 25 is welded to the mount portion 26, but the method of fixing the cover 25 is not limited to this. It is alternatively possible to, for example, a nail portion is made on the cover 25, which catches on an edge of the conductor portion 24B of each of the antennas 24. Here, the cover 25 may be fixed to the display cabinet 21 by engaging the nail portion with the conductor portion 24B.

The coaxial cable 31 includes a cable conductor 31A and a ground layer 31B surrounding the cable conductor 31A with an insulating portion interposed therebetween. The cable conductor 31A is connected to a first piece portion 32, which is a portion projecting towards the ground portion 24A, in the conductor portion 24B of the antenna 24. Further, the ground layer 31B is connected to a second piece portion 33 formed on the display cabinet 21. It should be noted that the housing referred to in the present invention is of a concept which includes the display cabinet 21, the main body cabinet 15 and the hinge portion 14. In this embodiment, the antennas 24 are housed inside the display cabinet 21. However, the present invention is not limited to this, but the antennas 24 may be provided inside the main body cabinet 15.

According to the first embodiment, the potable computer 11 comprises the metal-made housing including the opening portion 23, the antennas 24 each provided such as to partially overlap with the opening portion 23 inside the housing and carrying out radio communications with the outside, and the insulating cover 25 provided to close the opening portion 23. The cover 25 is fixed to the housing via the antennas 24. With this structure, since the opening portion 23 is provided in the metal-made housing, the shielding of radio waves by the housing can be suppressed, and therefore radio communications by the antennas 24 can be smoothly carried out. Further, the antennas 24 also function as a structure for supporting the cover 25, and therefore it is not necessary to provide a separate supporting structure. Therefore, it becomes possible to assure a sufficient space for installing the antennas 24. In this manner, the size of the housing can be reduced. Further, with the antennas 24 which can also function as the supporting structure for the cover 25, it is not necessary to provide this supporting structure separately, and thus the number of structural parts can be reduced.

In this embodiment, the antennas 24 are each made of a metal sheet such as to include the ground portion 24A having a flat plate-like shape and fixed to the housing, and a conductor portion 24B linearly projects from the ground portion 24A towards the opening portion 23. The conductor portion 243 includes the mount portion 26 to mount the cover 25. With this structure, the mount portion 26 for mounting the cover 25 to the conductor portion 24B, and therefore the conductor portion 24B projecting towards the opening portion 23 can be efficiently utilized as a portion to fix the cover 25.

In this embodiment, the antennas 24 are each formed to have a F-letter shape in reverse, and thus the conductor portion 24B bends in a direction parallel to the ground portion 24A at its middle portion. In this manner, the antennas 24 can be formed to be space-saving, and a plurality of antennas 24 can be arranged at a high density within a limited space. With this structure, the degree of freedom in the layout of the antennas 24 mounted inside the housing can be improved.

In this embodiment, the housing includes the main body cabinet 15 which houses the printed circuit board 16 inside, the display cabinet 21 which houses a display inside, and the hinge portion 14 provided at a position between the main body cabinet 15 and the display cabinet 21 and supporting the display cabinet 21 to be pivotable with respect to the main body cabinet 15. The opening portion 23 is provided in the display cabinet 21 at a position on an opposite side to the hinge portion 14.

With this structure, the antennas 24 are each located at a position distant from the hinge portion 14 inside the display cabinet 21. Therefore, while using the portable computer 11, the antennas 24 can be set at a high portion, which makes it possible to carry out transmission and reception of radio waves with a remote base station. As a result, radio communications by the antennas 24 can be smoothly carried out.

Next, with reference to FIG. 5, the second embodiment of the portable computer will now be described. A portable computer 41, which is an example of the electronic device of the second embodiment, is different from that of the first embodiment only in the structure to adhere the antennas 24 to the cabinet, and the other parts are common. Therefore, the following descriptions are made in connection with mainly the part different from that of the first embodiment. Parts common to both embodiments are designated by the same reference numerals, and the descriptions for these parts will be omitted.

A display unit 13 according to the second embodiment includes a metal-made display cabinet 21, a liquid crystal display 22 housed inside the display cabinet 21, an opening portion 23 made in the display cabinet 21, an antenna 24 provided inside the display cabinet 21, a insulating cover 25 provided to close the opening portion 23, and a metal-made adhesive film 42 which adheres the antenna 24 to the cabinet.

Inside the display cabinet 21, a coaxial cable 31 is arranged such as to detour the liquid crystal display 22. The coaxial cable 31 connects a radio module 17 to the antenna 24. Note that in FIG. 6, the illustration of the coaxial cable 31 is omitted.

The antenna 24 is formed of a metal sheet. The antenna 24 contains a ground portion 24A having a square plate shape, a conductor portion 24B projecting linearly from the ground portion 24A and a mount portion 26 formed on the conductor portion 24B. The conductor portion 24B projects towards the opening portion 23. The antenna 24 is formed to have a F-letter shape in reverse, and the conductor portion 24B bends in a direction parallel to the ground portion 24A in its middle portion.

The adhesive film 42 has a squire shape and has an area larger than that of the ground portion 24A. The adhesive film 42 is made of, for example, a copper foil or an aluminum foil. The adhesive film 42 has a tacky layer on its one side. The adhesive film 42 is adhered onto the ground portion 24A from an upper side such as to cover the ground portion 24A of the antenna 24. The adhesive film 42 serves to bond the antenna 24 to the housing such as to interpose the ground portion 24A between the housing and itself.

According to the second embodiment, the portable computer 41 further comprises the metal-made adhesive film 42 which has an area larger than that of the ground portion 24A, and the adhesive film 42 can bond the antenna 24 to the housing such as to interpose the ground portion 24A between the housing and itself. With this structure, it is possible to enhance the high-frequency coupling between the antenna 24 and the housing. In this manner, it is possible to form a stable ground portion 24A electrically connected to the housing, and therefore the radio communications by the antenna 24 can be carried out even more smoothly.

Next, with reference to FIG. 6, the third embodiment of the portable computer will now be described. A portable computer 51, which is an example of the electronic device of the third embodiment, is different from that of the first embodiment only in the shape of an antenna 52, and the other parts are common. Therefore, the following descriptions are made in connection with mainly the part different from that of the first embodiment. Parts common to both embodiments are designated by the same reference numerals, and the descriptions for these parts will be omitted.

The antenna 52 of the third embodiment is the so-called folded monopole antenna. The antenna 52 is formed of a copper-made metal sheet. The antenna 52 contains a ground portion 52A having a square plate shape, a conductor portion 52B projecting linearly from the ground portion 52A and a mount portion 26 formed on the conductor portion 52B. The ground portion 52A is adhered to the housing with, for example, a double-sided adhesive tape. The conductor portion 52B projects towards the opening portion 23 in a direction away from the ground portion 52A. The conductor portion 52B bends in a direction parallel to the ground portion 52A at its middle portion such as to have a U shape.

The mount portion 26 is a through hole made in a central portion of the conductor portion 52B. As the projection of the cover 25 is inserted to the mount portion 26, followed by heating, the projection of the cover 25 is welded to the mount portion 26.

A coaxial cable 31 includes a cable conductor 31A, and the cable conductor 31A is connected to a first piece portion 32, which is a portion projecting towards the ground portion 52A, in the conductor portion 52B. Further, the ground layer 31B is connected to a second piece portion 33 formed on the ground portion 52A.

According to the third embodiment, the antenna 52 is formed into a shape of the so-called folded monopole antenna, but it can also serve as a supporting structure for the cover 25 due to the conductor portion 52B of the antenna 52. With this structure, it is not necessary to provide a separate structure which supports the cover 25, and therefore a sufficient space for installing the antenna 52 can be secured.

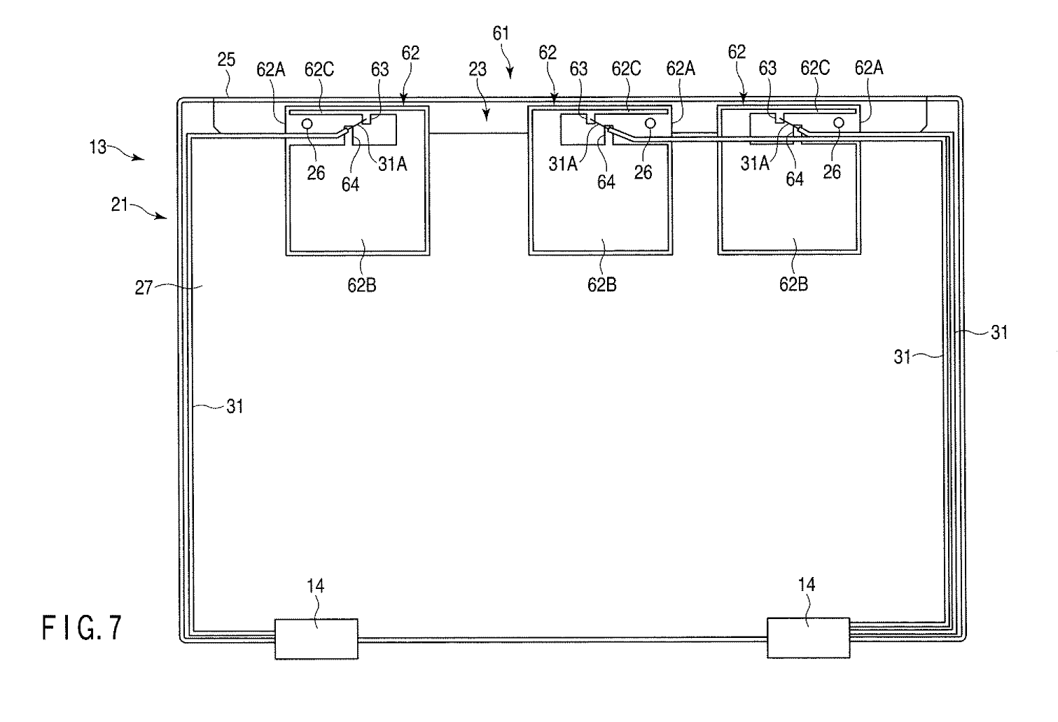

Next, with reference to FIG. 7, the fourth embodiment of the portable computer will now be described. A portable computer 61, which is an example of the electronic device of the fourth embodiment, is different from that of the first embodiment only in the structure of an antenna 62, and the other parts are common. Therefore, the following descriptions are made in connection with mainly the part different from that of the first embodiment. Parts common to both embodiments are designated by the same reference numerals, and the descriptions for these parts will be omitted.

The antenna 62 of the fourth embodiment is formed as a conductor pattern printed on a substrate 62A by, for example, screen printing. The antenna 62 contains a substrate 62A having a square shaper a ground portion 62B formed to have a square plate shape on the substrate 62A, a conductor portion 62C formed on the substrate 62A such as to project linearly from the ground portion 62B and a mount portion 26 for mounting the cover 25. The mount portion 26 is formed as a through hole at a position out from the conductor portion 62C and the ground portion 62B.

The substrate 62A is formed of, for example, a glass epoxy substrate. The substrate 62A is adhered to the display cabinet 21 with, for example, a double-sided adhesive tape. The conductor portion 62C projects towards the opening portion 23 in a direction away from the ground portion 62B. The conductor portion 62C bends in a direction parallel to the ground portion 62B at its middle portion.

A coaxial cable 31 includes a cable conductor 31A, and the cable conductor 31A is connected to a first piece portion 63, which is a portion projecting towards the ground portion 62B, in the conductor portion 62C of the antenna 62. Further, the ground layer 31B of the coaxial cable 31 is connected to a second piece portion 64 formed on the ground portion 62B.

According to the fourth embodiment, the antenna 62 includes the substrate fixed to the housing, the ground portion 62B formed to have a square plate shape on the substrate 62A and the conductor portion 62C formed on the substrate 62A such as to project linearly from the ground portion 62B towards the opening portion 23. Further, the substrate 62A includes the mount portion 26 for mounting the cover 25. With this structure, the antenna 62 constituted by the conductor pattern formed on the substrate 62A can also serve as a support structure for the cover 25. As a result, it is not necessary to provide a separate structure which supports the cover 25, and therefore a sufficient space for installing the antenna 62 can be secured.

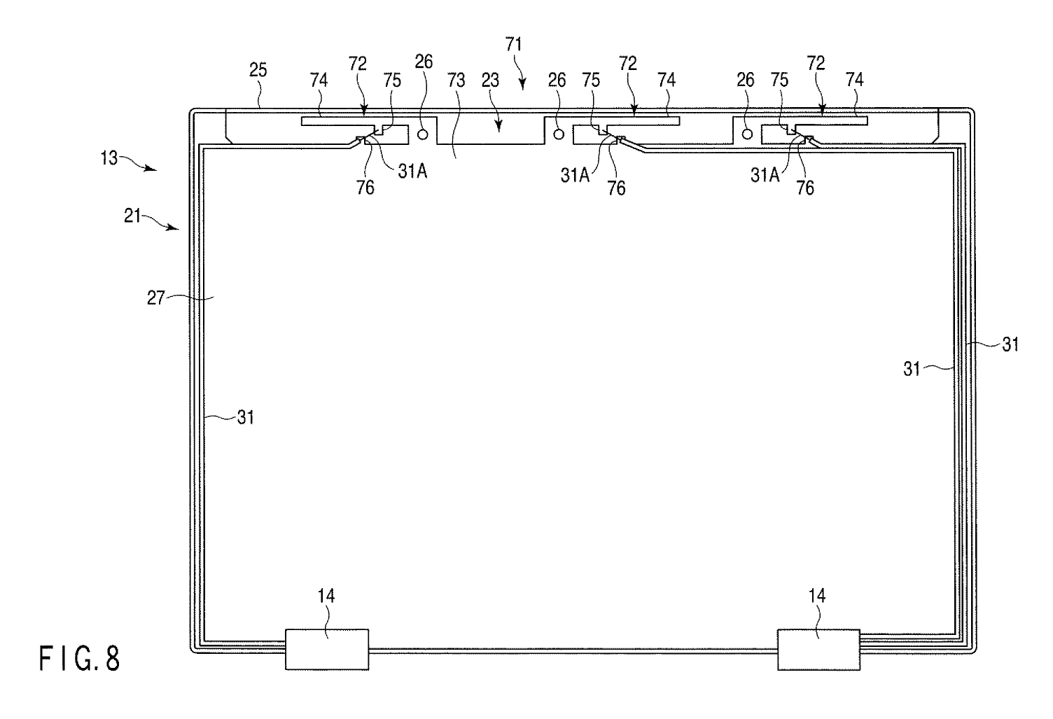

Next, with reference to FIG. 8, the fifth embodiment of the portable computer will now be described. A portable computer 71, which is an example of the electronic device of the fifth embodiment, is different from that of the first embodiment in the respect that an antenna is formed to be integrated with a display cabinet 21, and the other parts are common. Therefore, the following descriptions are made in connection with mainly the part different from that of the first embodiment. Parts common to both embodiments are designated by the same reference numerals, and the descriptions for these parts will be omitted.

The display unit 13 includes a metal-made display cabinet 21, a liquid crystal display 22, which is an example of the display housed inside the display cabinet 21, an opening portion 23 made in the display cabinet 21, an antenna portion 72 formed to be integrated with the display cabinet 21, and a insulating cover 25 provided to close the opening portion 23. The cover 25 includes a projection not shown in the figure, to be welded to a mount portion 26 of the antenna portion 72, which will be described later.

The display cabinet 21 includes a back cover 27 which covers a back portion of the liquid crystal display 22 and a frame-like mask 28 which surrounds a front portion of the liquid crystal display 22.

The back cover 27 includes a main body 73 which also serves as a ground for the antenna portion 72, a conductor portion 74 linearly projecting from the main body 73 and a mount portion 26 formed in the conductor portion 74. The conductor portion 74 projects towards the opening portion 23 and forms a part of the antenna portion 72. The conductor portion 74 extends in a direction away from the main body 73 which also serves as the ground, but it bends in a direction parallel to the main body 73 at its middle portion. The antenna portion 72 is formed to have a F-letter shape in reverse.

The mount portion 26 is a through hole made in a central portion of the conductor portion 74. As the projection of the cover 25 is inserted to the mount portion 26, followed by heating, the projection is welded to the mount portion 26. Further, a coaxial cable 31 includes a cable conductor 31A, and the cable conductor 31A is connected to a first piece portion 75, which is a portion projecting towards the main body 73, in the conductor portion 74 of the antenna 24. Further, the ground layer 31B of the coaxial cable 31 is connected to a second piece portion 76 formed on the display cabinet 21.

According to the fifth embodiment, the portable computer 71 includes the metal-made housing including the opening portion 23, the insulating cover 25 provided to close the opening portion 23, the antenna portion 72 formed to be integrated with the housing in the vicinity of the opening portion 23 and carrying out radio communications with the outside. Further, the cover 25 is fixed to the housing via the antenna portion 72. With this structure, it is not necessary to provide a separate structure which supports the cover 25, and therefore a sufficient space for installing the antenna portion 72 can be secured. Further, the antenna portion 72 is formed to be integrated with the cabinet, and therefore there is no need to prepare, for example, a double-side adhesive tape for bonding the antenna 24 to the cabinet. Thus, the manufacturing process can be simplified and the number of structural parts can be reduced. It should be noted that in this embodiment, the antenna portion 72 is formed to be integrated with the display cabinet 21 of the cabinet; however the invention is not limited to this, but it may be integrated with the main body cabinet of the housing.

In this embodiment, the cabinet includes the main body 73 which also serves as a ground for the antenna portion 72, the conductor portion 74 linearly projecting from the main body 73 towards the opening portion 23 such as to form a part of the antenna portion 72. Further, the conductor portion 74 includes the mount portion 26 for mounting the cover 25. With this structure, the conductor portion 74 projecting towards the opening portion 23 can be effectively utilized as a part for fixing the cover 25.

The antenna portion 72 is formed to have a F-letter shape in reverse, and therefore the conductor portion 74 bends in a direction parallel to the main body 73 at its middle portion. In this manner, the antenna portion 72 can be formed to be space-saving, and the space required to install the antenna can be made smaller.

The electronic device of the present invention is not limited to the above-provided embodiments. Further, the electronic device of the present invention can be applied not only portable computers but also to mobile telephones. Furthermore, naturally, the electronic device of the present invention can be remodeled into various versions as long as it does not fall out of the scope of the invention.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are Intended to cover such forms or modifications as would fall within the scope and spirit of the inventions.

What is claimed is:

1. An electronic device comprising:
a metal-made housing including an opening portion;
an antenna provided to partially overlap with the opening portion within the housing, with which radio communications are carried out with an outside; and
an insulating cover provided to close the opening portion;
wherein the cover is fixed to the housing via the antenna.

2. The electronic device of claim 1, wherein the antenna is formed of a metal sheet such as to include a ground portion formed into a flat plate-like shape and fixed to the housing, and a conductor portion linearly projecting from the ground portion towards the opening portion, and
the conductor portion includes a mount portion with which the cover is mounted.

3. The electronic device of claim 2, wherein the antenna is a reverse letter-F shaped antenna.

4. The electronic device of claim 3, further comprising a metal-made adhesive film having an area larger than that of the ground portion,
wherein the adhesive film bonds the antenna to the housing such as to interpose the ground portion between the housing and the adhesive film itself.

5. The electronic device of claim 4, wherein the housing further includes:
a main body cabinet which houses a printed circuit board inside;
a display cabinet which houses a display inside; and
a hinge portion provided at a position between the main body cabinet and the display cabinet, which supports the display cabinet such as to be pivotable with respect to the main body cabinet, and
the opening portion is provided in the display cabinet at a position on an opposite side to the hinge portion.

6. The electronic device of claim 1, wherein the antenna includes a substrate fixed to the housing, a ground portion formed into a flat plate-like shape on the substrate and a conductor linearly projecting from the ground portion towards the opening portion, and
the substrate includes a mount portion with which the cover is mounted.

7. The electronic device of claim 6, wherein the housing further includes:
a main body cabinet which houses a printed circuit board inside;
a display cabinet which houses a display inside; and
a hinge portion provided at a position between the main body cabinet and the display cabinet, which supports the display cabinet such as to be pivotable with respect to the main body cabinet, and
the opening portion is provided in the display cabinet at a position on an opposite side to the hinge portion.

8. An electronic device comprising:
a metal-made housing including an opening portion;
an insulating cover provided to close the opening portion; and
an antenna integrated into the housing in a vicinity of the opening portion, with which radio communications are carried out with an outside;
wherein the cover is fixed to the housing via the antenna.

9. The electronic device of claim 8, wherein the housing further includes:
a main body which also serves as a ground for the antenna; and
a conductor portion linearly projecting from the main body towards the opening portion, which forms a part of the antenna,
wherein the conductor portion includes a mount portion with which the cover is mounted.

10. The electronic device of claim 9, wherein the antenna is a reverse letter-F shaped antenna.

11. The electronic device of claim 10, wherein the housing further includes:
a main body cabinet which houses a printed circuit board inside;
a display cabinet which houses a display inside; and
a hinge portion provided at a position between the main body cabinet and the display cabinet, which supports the display cabinet such as to be pivotable with respect to the main body cabinet, and
the opening portion is provided in the display cabinet at a position on an opposite side to the hinge portion.
